(19) United States
(12) Patent Application Publication
(10) Pub. No.: US 2004/0069067 A1
(43) Pub. Date: Apr. 15, 2004

(54) Fluorescence measurement apparatus and method

(76) Inventors: Guiseppe Mancinone, Western Australia (AU); Ian Mawson Howard, Western Australia (AU); Paul Andrew Gould, Western Australia (AU)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/467,949

(22) PCT Filed: Feb. 22, 2002
(86) PCT No.: PCT/AU01/00181

(30) Foreign Application Priority Data
Feb. 23, 2001 (AU) PR3294
Nov. 20, 2001 (AU) PR8946

(51) Int. Cl. G01H 1/00

(52) U.S. Cl. 73/653; 73/654

(57) ABSTRACT

A vibration measuring apparatus (10) inlcudes an accelerometer (12) which is contained within a surface micromachined integrated chip, and signal processing means including a high pass filter (14), a low pass filter (16) and an integrator (18).

### FIELD OF THE INVENTION

The present invention relates to a vibration measurement apparatus.

The monitoring and analysis of the vibration of a machine can be a key means of assessing the condition of the machine, and predicting failure of certain components within the machine.

Various types of apparatus have been used to measure machine vibration. These include eddy current probes, moving element velocity pick-ups, and piezoelectric accelerometers. The most common type of apparatus used is a piezoelectric accelerometer.

There are several problems encountered with the use of piezoelectric accelerometers in measuring machine vibration. One problem is that of mass loading, whereby the mass of the accelerometer can distort the true vibration level of a structure. Another problem is that apparatus incorporating sensitive piezoelectric accelerometers is often large and expensive to manufacture, and therefore it is not always possible or economic to incorporate permanent vibration measuring devices into some machines. The present invention attempts to overcome at least in part some of the aforementioned disadvantages of previous vibration measuring apparatus.

### DISCLOSURE OF THE INVENTION

In accordance with one aspect of the present invention there is provided a vibration measuring apparatus comprising an accelerometer and a signal processing means arranged to receive a signal from the accelerometer and to produce an output signal, characterised in that the accelerometer is a contained within a surface micro machined integrated circuit chip.

Preferably, the signal processing means comprises a low pass filter, a high pass filter and an integrator.

### BRIEF DESCRIPTION OF THE DRAWINGS

The present invention will now be described, by way of example, with reference to the accompanying drawings, in which:

FIG. 1 is a flow chart representation of a vibration measuring apparatus in accordance with a first embodiment of the present invention;

FIG. 2 is a flow chart representation of a vibration measuring apparatus in accordance with a second embodiment of the present invention;

FIG. 3 is a flow chart representation of a vibration measuring apparatus in accordance with a third embodiment of the present invention; and

FIG. 4 is a flow chart representation of a vibration measuring apparatus in accordance with a fourth embodiment of the present invention.

### DESCRIPTION OF THE INVENTION

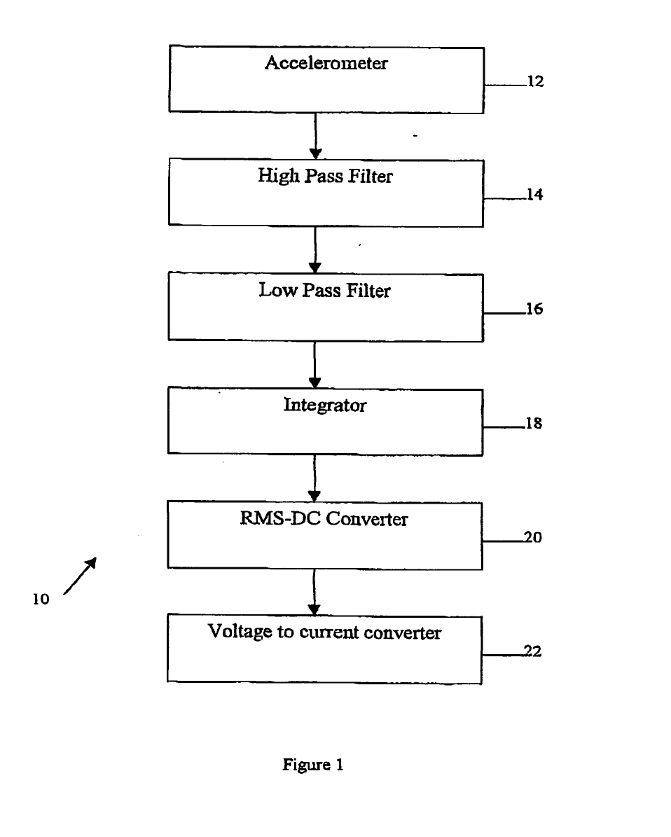

Referring to FIG. 1, there is shown a conceptual representation of a vibration measuring apparatus 10. The vibration measuring apparatus 10 comprises an accelerometer 12, and a signal processing means comprising a high pass filter 14, a low pass filter 16, and an integrator 18.

The accelerometer 12 is constructed as part of a micro machined integrated circuit chip. A typical micro machined accelerometer 12 is comprised of a differential capacitor structure comprising two fixed plates and a moving plate supported by springs. Acceleration of the structure causes movement of the moving plate relative to the fixed plates. This movement causes a change in the capacitance of the structure, and can be measured as a change in the voltage measured across the accelerometer.

Micro machined accelerometers have been previously used for applications requiring the detection of a sudden acceleration or deceleration. These applications include automotive airbag actuation mechanisms. They have also been used in applications requiring tilt detection, such as in free air computer peripherals.

Previous attempts to use micro machined accelerometers in vibration monitoring applications have resulted in inaccurate results. It has now been discovered that accelerometer resonance is a substantial contributor to this inaccuracy. Circuit noise provides an additional source of inaccuracy.

A further contributor to this inaccuracy is that integration of an acceleration signal to form a velocity signal results in a low signal magnitude for higher frequencies. The acceleration response of a vibrating body at a particular frequency can be described by the equation

α=A cos(2π ft)

Integration of this equation to obtain velocity gives

ν=A/2πf sin(2π ft)

The magnitude of the velocity signal thus decreases with an increase in frequency. Attempts to magnify this signal volume have the effect of magnifying errors in the signal measurement, and also of magnifying the DC offset of the signal.

The present invention provides an alternative method for obtaining a velocity response at higher frequencies.

The accelerometer 12 is mounted to a machine so as to be able to generate a signal representing vibration of the machine. This signal, which may be deemed a raw signal, is typically an alternating voltage signal.

The raw signal typically comprises a combination of waveforms generated by the machine vibration, accelerometer resonance and ambient noise.

The raw signal is input to the high-pass filter 14. The high-pass filter 14 acts to remove elements of the signal with frequencies below a predetermine level. In use, the high pass filter 14 acts to substantially decrease the ambient noise component of the signal. In a typical example, a high pass filter 14 with a lower frequency limit of 10 Hz may be used to eliminate typical ambient noise which is below 10 Hz.

The high pass filtered signal is then input to the low pass filter 16. The low pass filter 16 acts to remove elements of the signal with frequencies above a predetermined level. In use, the low pass filter 16 acts to remove that part of the signal associated with accelerometer resonance. Typically, accelerometer resonance occurs above 2 kHz, and a low pass filter 16 with an upper frequency limit of 2 kHz may be used to remove accelerometer resonance.

The filtered signal is then passed to the integrator 18 in order to convert the acceleration signal to a velocity signal according to the equation above. In a typical example, the integrator will include a DC gain of 1 at a frequency of 500 Hz.

The use of a low resistor value in the high pass filter, typically approximately 100 kΩ, has the effect of reducing the DC voltage drop across the low pass filter to approximately 1 mV, and the DC offset of the integrated signal to within a 1V range.

The velocity signal thus obtained represents the motion of the machine to which the vibration measuring apparatus 10 is coupled.

This velocity signal can be subject to a number of signal processing techniques according to particular needs identified.

In a first embodiment, as shown in FIG. 1, the velocity signal (an alternating voltage signal) is fed to an RMS-DC converter 20 in order to obtain a single representative value for the machine vibration. The RMS-DC converter 20 converts the root mean square valve of the alternating voltage signal into a DC voltage. The magnitude of this DC voltage represents the amount of vibration the machine is undergoing. The output of the RMS-DC converter 20 may then be converted to a current by a voltage to current converter 22 in order to be input into a programmable logic controller.

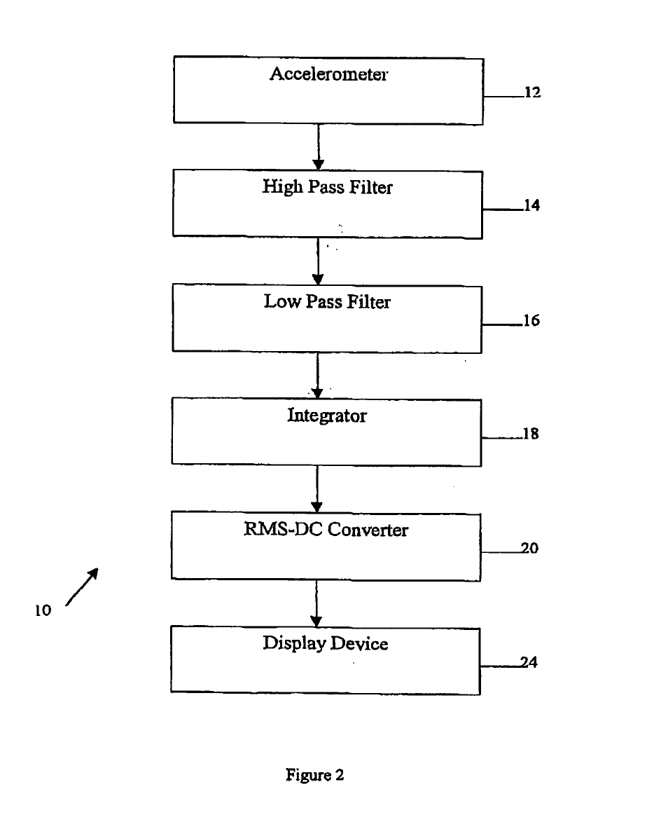

In a second embodiment, as shown in FIG. 2, the signal from the RMS-DC converter 20 is transmitted directly to a display device 24. The display device 24 may be in the form of a series of lights such as light emitting diodes. The display device 24 may be arranged so that the number of lights displayed may correspond to particular levels of signal received from the RMS-DC converter 20. The lights ray be of different colours.

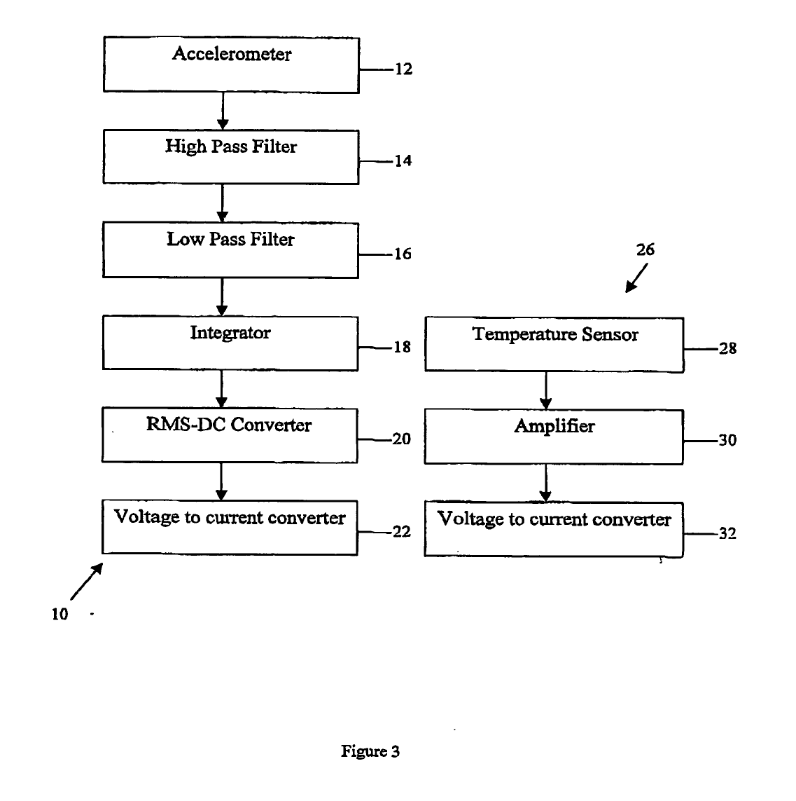

A third embodiment of the present invention is shown in FIG. 3. In this embodiment the vibration measuring apparatus 10 fixer includes a temperature measuring portion 26. The temperature measuring portion 26 includes a temperature sensor 28, an amplifier 30 and a second voltage to current converter 32.

In use, the output from the temperature sensor 28 is amplified by the amplifier 30 and converted to a current by the second voltage to current converter 32. This signal can then be input into a programmable logic controller.

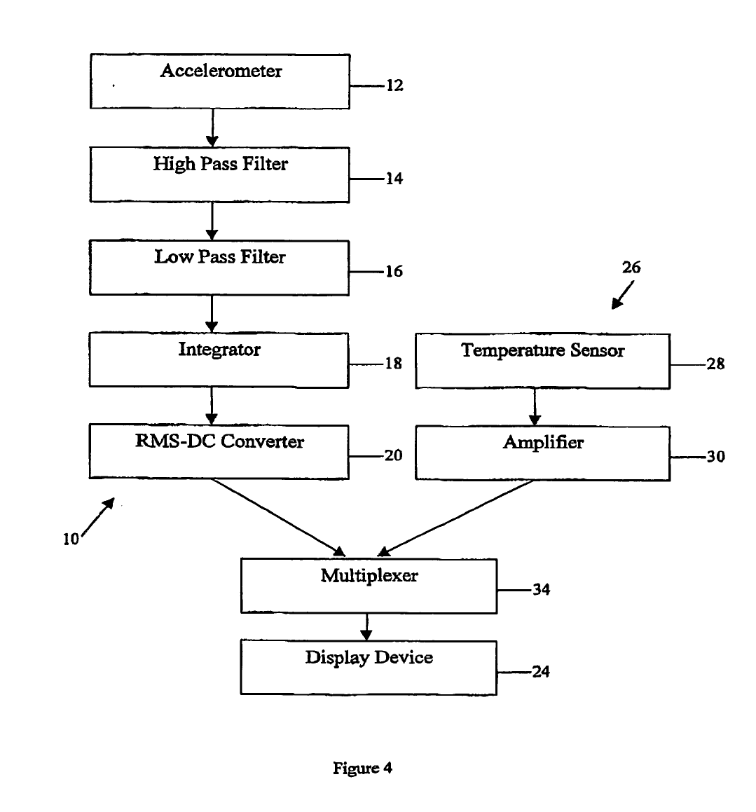

A fourth embodiment of the present invention is shown in FIG. 4. In this embodiment the signals from the RMS-DC converter 20 and the amplifier 30 are fed to a multiplexer 34. In this embodiment the multiplexer 34 controls the display device 24, and may be arranged to alternately display information concerning the vibration and the temperature being measured.

It will be appreciated that when a display device 24 is used then the vibration measuring apparatus 10 may be battery operated and therefore completely self contained. It may be arranged to have a switching arrangement so that the vibration measuring apparatus 10 is only operative when a user depresses a switch.

Further embodiments are also envisaged. For instance, the velocity signal or acceleration signal may be subjected to spectral analysis in order to identify particular sources of vibration.

Modifications and variations as would be apparent to a skilled addressee are deemed to be within the scope of the present invention. For instance, the signal processing means may comprise digital or analog signal processing components or a combination of digital and analog signal processing components. Further, diagnostic components and analysis may be added to the vibration measuring apparatus 10 in order to diagnose particular machine faults. These components may be integrated onto a single chip. This may be done by means of large scale integration. The information thus obtained may then be communicated by communication means such as computer networks or wireless communication means to a remote location. It will also be appreciated that more than one accelerator may be used, for instance in order to measure vibration on more than one axis.

1. A machine vibration measuring apparatus comprising an accelerometer and a signal processing means arranged to receive a signal from the accelerometer and to produce an output signal characterised in that the accelerometer is contained within a surface micro machined integrated chip, and wherein the signal processing means includes a low pass filter, the low pass filter acting to remove accelerometer resonance from the signal.

2. A machine vibration measuring apparatus as claimed in claim 1, characterised in that the low pass filter is arranged to remove frequencies above 2 kHz.

3. A machine vibration measuring apparatus as claimed in claim 1 or claim 2, characterised in that the signal processing means further comprises a high pass filter.

4. A machine vibration measuring apparatus as claimed in claim 3, characterised in that the high pass filter is arranged to remove frequencies below 10 Hz.

5. A machine vibration measuring apparatus as claimed in claim 3 or claim 4, characterised in that the high pass filter incorporates a resistor value of approximately 100 kΩ.

6. A machine vibration measuring apparatus as claimed in any one of the preceding claims, characterised in that the signal processing means further comprises an integrator.

7. A machine vibration measuring apparatus as claimed in claim 6, characterised in that the integrator has a DC gain of about 1 at a frequency of 500 Hz.

8. A machine vibration measuring apparatus as claimed in claim 1, characterised in that the signal processing means further comprises a high pass filter, and an integrator.

9. A machine vibration measuring apparatus as claimed in claim 8, characterised in that the signal is arranged to pass in turn through the high pass filter, the low pass filter and the integrator.

10. A machine vibration measuring apparatus as claimed in claim 8 or claim 9, characterised in that the signal processing means further comprises an RMS-DC converter.

11. A machine vibration measuring apparatus as claimed in claim 10, characterised in that the signal processing means further comprises a voltage to current converter.

12. A machine vibration measuring apparatus as claimed in any one of the above claims, characterised in that the vibration measuring apparatus her comprises a display device arranged to display the output signal.

13. A machine vibration measuring apparatus as claimed in claim 12, characterised in that the display device is a series of lights.

14. A machine vibration measuring apparatus as claimed in any one of the preceding claims, characterised in that the vibration measuring apparatus further comprises a temperature measuring portion.

15. A machine vibration measuring apparatus as claimed in any one of the preceding claims, characterised in that the vibration measuring apparatus is selectively operative by way of a switch.

16. A machine vibration measuring apparatus as claimed in any one of the preceding claims, characterised in that the signal processing means is comprised of digital components.

17. A machine vibration measuring apparatus as claimed in any one of claims 1 to 16, characterised in that the signal processing means is comprised of analogue components.
